(19) United States
(12) Patent Application Publication
(10) Pub. No.: US 2011/0254923 A1
(43) Pub. Date: Oct. 20, 2011

(54) Image processing apparatus, method and computer-readable medium

(75) Inventors: Ouk Choi, Yongin-si (KR); Hwa Sup Lim, Hwaseong-si (KR); Byong Min Kang, Yongin-si (KR); Yong Sun Kim, Yongin-si (KR); Kee Chang Lee, Yongin-si (KR); Seung Kyu Lee, Seoul (KR)

(73) Assignee: Samsung Electronics Co., Ltd., Suwon-si (KR)

(21) Appl. No.: 12/926,316

(22) Filed: Nov. 9, 2010

(30) Foreign Application Priority Data
Apr. 19, 2010 (KR) 10-2010-0035683

(51) Int. Cl. H04N 13/02; G06K 9/00

(52) U.S. Cl. 348/46; 382/154; 348/E13.074

(57) ABSTRACT

Provided is an image processing apparatus, method and computer-readable medium. The image processing apparatus may perform modeling of a function that enables correction of a systematic error of a depth camera, using a single depth camera and a single calibration reference image. Additionally, the image processing apparatus may calculate a depth error or a distance error of an input image, and may correct a measured depth of the input image using a modeled function.

### CROSS-REFERENCE TO RELATED APPLICATIONS

This application claims the benefit of Korean Patent Application No. 10-2010-0035683, filed on Apr. 19, 2010, in the Korean Intellectual Property Office, the disclosure of which is incorporated herein by reference.

### BACKGROUND

1. Field

Example embodiments of the following description relate to an image processing apparatus, method and computer-readable medium, and more particularly, to correction of a depth error occurring based on a measured depth or a measured luminous intensity.

2. Description of the Related Art

A depth camera may provide in real-time, depth values of all pixels using a Time Of Flight (TOF) function. Accordingly, the depth camera may be mainly used to perform modeling of a 3D object and to estimate a 3D object. However, generally, there is an error between an actual depth value and a depth value measured by the depth camera. Thus, there is a demand for technologies to minimize the error between the actual depth value and the measured depth value.

### SUMMARY

The foregoing and/or other aspects are achieved by providing an image processing apparatus including a receiver to receive a depth image and a brightness image, and to output a three-dimensional (3D) coordinate of a target pixel and a depth of the target pixel, the depth image and the brightness image captured by a depth camera, and the 3D coordinate and the depth measured by the depth camera, a correction unit to read a depth error corresponding to the measured depth from a storage unit, and to correct the measured 3D coordinate using the read depth error, and the storage unit to store the depth error, wherein a plurality of depth errors stored in the storage unit are corresponded to at least one of a plurality of depths and a plurality of luminous intensities.

The receiver may output luminous intensities of a plurality of pixels measured by the depth camera to the correction unit.

The correction unit may read, from the storage unit, the depth error corresponded to the measured depth and the measured luminous intensity, and may correct the measured 3D coordinate using the read depth error.

The correction unit may correct the measured 3D coordinate using the following equation:

$$X = \frac{R}{{R}_{D}} {X}_{D} ,$$

where R=R_{D}+ΔR, R denotes an actual depth, R_{D} denotes the measured depth, ΔR denotes the depth error corresponding to the measured depth among the plurality of depth errors stored in the storage unit, X_{D} denotes the measured 3D coordinate, and X denotes an actual 3D coordinate.

The plurality of depth errors stored in the storage unit may be calculated based on differences between actual depths of reference pixels of a reference image and measured depths of the reference pixels.

The actual depths of the reference pixels may be calculated by placing measured 3D coordinates of the reference pixels on a same line as actual 3D coordinates of the reference pixels, and projecting the measured 3D coordinates and the actual 3D coordinates onto a depth image of the reference image.

The plurality of depth errors stored in the storage unit may be calculated using a plurality of brightness images and a plurality of depth images. Here, the plurality of brightness images and the plurality of depth images may be acquired by capturing a same reference image at different locations and different angles.

The reference image may be a pattern image where a same pattern is repeated, and the same pattern may have different luminous intensities.

The image processing apparatus may further include a color corrector to correct a color image received from the receiver.

The foregoing and/or other aspects are achieved by providing an image processing method including receiving, by at least one processor, a depth image and a brightness image, the depth image and the brightness image captured by a depth camera, outputting a 3D coordinate of a target pixel and a depth of the target pixel, the 3D coordinate and the depth measured by the depth camera, reading, by the at least one processor, a depth error corresponding to the measured depth from a storage unit, the depth error stored in the storage unit, and correcting, by the at least one processor, the measured 3D coordinate using the read depth error, wherein a plurality of depth errors stored in the lookup table are corresponded to at least one of a plurality of depths and a plurality of luminous intensities.

The receiving may include outputting luminous intensities of a plurality of pixels, the luminous intensities measured by the depth camera. The correcting may include reading, from the storage unit, the depth error corresponded to the measured depth and the measured luminous intensity, and correcting the measured 3D coordinate using the read depth error.

The correcting may include correcting the measured 3D coordinate using the following equation:

$$X = \frac{R}{{R}_{D}} {X}_{D} ,$$

where R=R_{D}+ΔR, R denotes an actual depth, R_{D} denotes the measured depth, ΔR denotes the depth error, X_{D} denotes the measured 3D coordinate, and X denotes an actual 3D coordinate.

The foregoing and/or other aspects are achieved by providing an image processing method including capturing, by at least one processor, a calibration reference image by a depth camera, and acquiring a brightness image and a depth image, calculating, by the at least one processor, an actual depth of a target pixel by placing a 3D coordinate of the target pixel measured by the depth camera on a same line as an actual 3D coordinate of the target pixel, calculating, by the at least one processor, a depth error of the target pixel using the calculated actual depth and a depth of the measured 3D coordinate, and performing modeling, by the at least one processor, of the calculated depth error using a function of measured depths of reference pixels when all depth errors of the reference pixels are calculated, where the measured depths are depths of 3D coordinates obtained by measuring the reference pixels.

The performing of modeling may include performing modeling of the calculated depth error using a function of the measured depths of the reference pixels and luminous intensities of the reference pixels.

The calculating of the actual depth may include calculating the actual depth of the target pixel by projecting the measured 3D coordinate of the target pixel and the actual 3D coordinate of the target pixel onto a same pixel of the depth image, and placing the measured 3D coordinate of the target pixel on the same line as the actual 3D coordinate of the target pixel.

The foregoing and/or other aspects are achieved by providing a method, including capturing, by at least one processor, a brightness image and a depth image, calculating, by the at least one processor, a depth and a 3D coordinate of a target pixel, determining, by the at least one processor, a depth error by comparing the depth of the target pixel with a table of depth errors and correcting the 3D coordinate using the depth error.

According to another aspect of one or more embodiments, there is provided at least one non-transitory computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a diagram of examples of a reference image, a depth image, and a brightness image that are used to obtain a depth error according to example embodiments;

FIG. 2 illustrates a diagram of examples of a plurality of brightness images acquired by capturing a reference image according to example embodiments;

FIG. 3 illustrates a diagram of examples of pattern planes of brightness images where calibration is performed according to example embodiments;

FIG. 4 illustrates a diagram of a relationship between three-dimensional (3D) coordinates and brightness images where calibration is performed according to example embodiments;

FIG. 5 illustrates a diagram of an example of modeling depth errors using a function of a measured depth according to example embodiments;

FIG. 6 illustrates another example of modeling depth errors using the measured depths and luminous intensities;

FIG. 7 illustrates a flowchart of an operation of calculating a depth error according to example embodiments;

FIG. 8 illustrates a block diagram of an image processing apparatus according to example embodiments; and

FIG. 9 illustrates a flowchart of an image processing method of an image processing apparatus according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

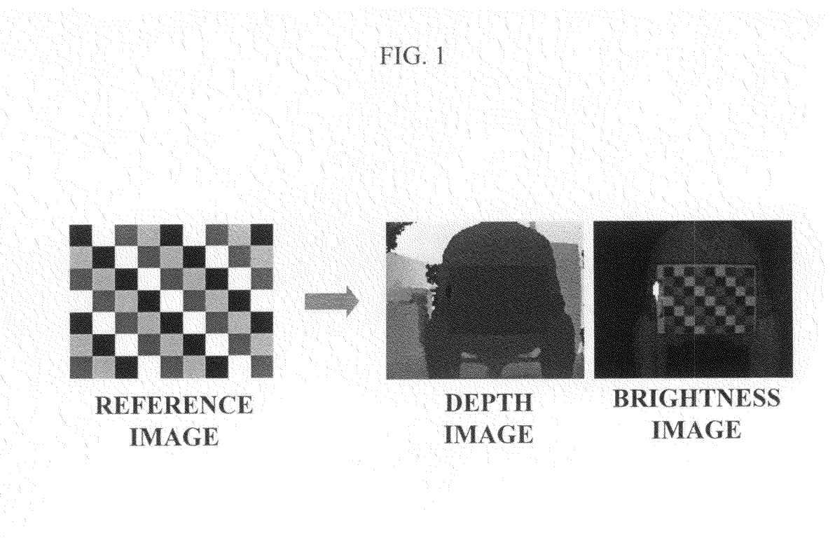

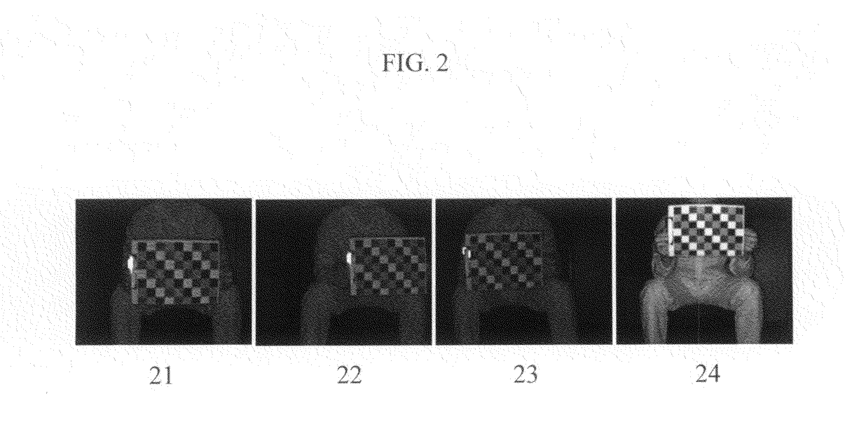

FIG. 1 illustrates examples of a reference image, a depth image, and a brightness image that are used to calculate a depth error. FIG. 2 illustrates examples of a plurality of brightness images acquired by capturing a reference image.

Referring to FIG. 1, the reference image may be a calibration pattern image used to estimate a depth error in an experiment. The reference image may include an image having a pattern where a same pattern is repeated, and the same pattern may have different luminous intensities. For example, when the reference image has a lattice pattern as shown in FIG. 1, neighboring lattices may be designed to have different luminous intensities.

A depth camera may capture the reference image, and may acquire a depth image and a brightness image. Specifically, the depth camera may capture the reference image at different locations and different angles, and may acquire various depth images, and various brightness images 21 through 24 shown in FIG. 2.

The depth camera may irradiate a light source, such as infrared (IR) rays onto an object to detect a light reflected from the object, and thereby may calculate a depth. The depth camera may obtain a depth image representing the object, based on the calculated depth. The depth refers to a distance measured between the depth camera and each point (for example, each pixel) of the depth image representing the object. Additionally, the depth camera may measure an intensity of the detected light, and may obtain a brightness image using the measured intensity of the detected light. A luminous intensity refers to brightness or an intensity of light which is emitted from the depth camera, reflected from an object and returned to the depth camera.

An image processing apparatus may perform modeling of a function that is used to correct a depth error from a depth image and a brightness image.

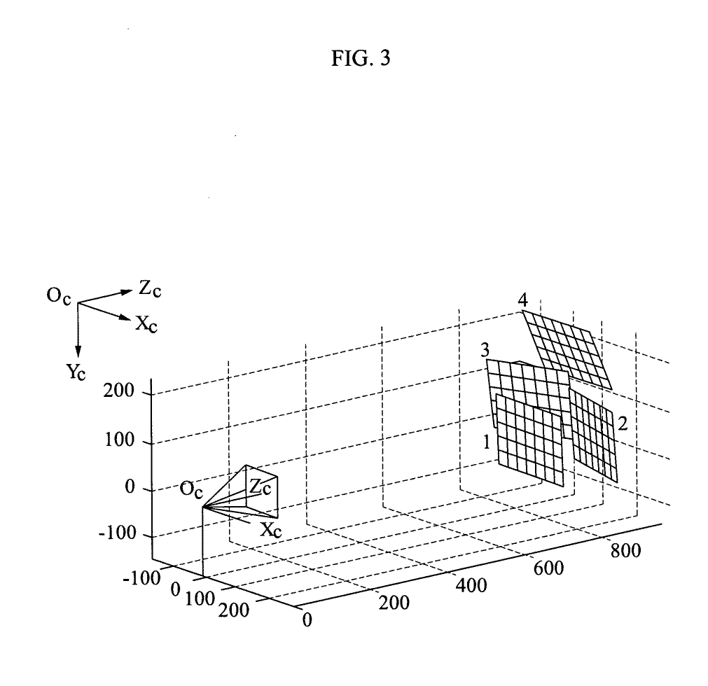

Specifically, the image processing apparatus may apply a camera calibration scheme to the acquired brightness images 21 through 24 shown in FIG. 2. The image processing apparatus may perform the camera calibration scheme to extract an intrinsic parameter, and to calculate locations and angles of the brightness images 21 through 24 based on a location of the depth camera, as shown in FIG. 3. The intrinsic parameter may include, for example, a focal length of a depth camera, a center of an image, and a lens distortion.

FIG. 3 illustrates examples of pattern planes of brightness images where calibration is performed according to example embodiments. In FIG. 3, O_{C}, X_{C}, Y_{C}, and Z_{C} denote coordinate systems of pattern planes 1 through 4. Additionally, the pattern planes 1 through 4 with lattice patterns may be calculated by calibration of the brightness images 21 through 24.

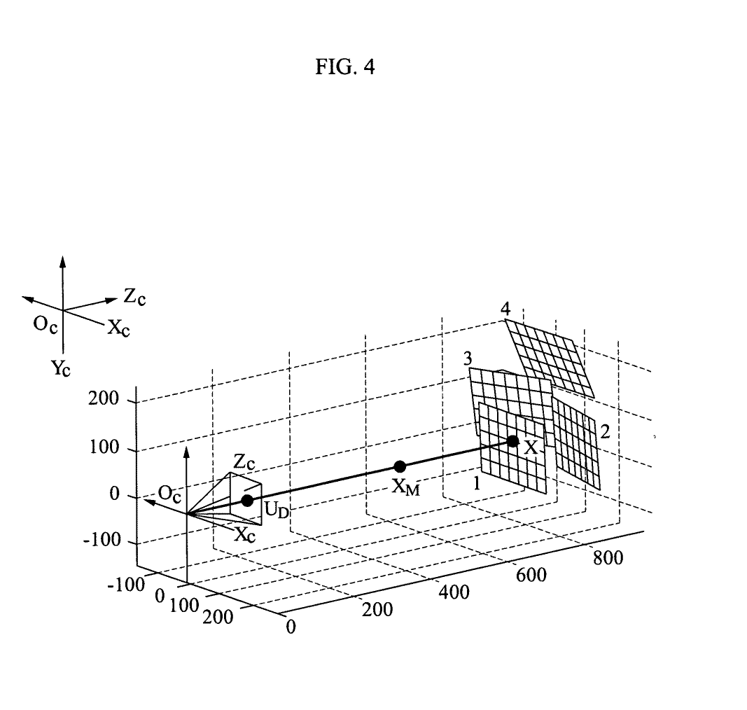

FIG. 4 illustrates a diagram of a relationship between three-dimensional (3D) coordinates and brightness images where calibration is performed according to example embodiments.

The image processing apparatus may search for pixels corresponding to centers of lattice patterns from the brightness images 21 through 24. For example, when the brightness image 21 has a 9×6 lattice pattern, the image processing apparatus may search for pixels located on a center of the 9×6 lattice pattern. Hereinafter, the searched pixels are referred to as reference pixels.

When a location (x, y) of a target pixel on a plane bearing a color image is indicated by U_{D}, the image processing apparatus may check a 3D coordinate X_{M} measured at U_{D} from a depth image. Here, the target pixel refers to a pixel to be currently processed among all reference pixels found as a result of searching from the brightness images 21 through 24. A depth Rₘ of the target pixel measured by a depth camera may be represented by the following Equation 1:

Rₘ=\sqrt{Xₘ²+Yₘ²+Zₘ²} [Equation 1]

In Equation 1, Xₘ=X_{M}=(Xₘ, Yₘ, Zₘ)^{T}.

A depth measurement coordinate system representing X_{M} may be different from a camera coordinate system used in the camera calibration scheme. To match the two coordinate systems, the image processing apparatus may transform X_{M} measured by the depth measurement coordinate system to X_{D}, namely a point of the camera coordinate system. The transformation of the coordinate system may be represented by a 3D rotation R and a parallel translation T, as shown in Equation 2, below:

X_{D}=R_{M→D}X_{M}+T_{M→D} [Equation 2]

In Equation 2, X_{M} denotes a coordinate measured by the depth measurement coordinate system, and R_{M→D} denotes a 3D rotation to transform X_{M} to the camera coordinate system. Additionally, T_{M→D} denotes a parallel translation of the 3D rotation X_{M}, and X_{D} denotes a 3D coordinate obtained by transforming X_{M} to the camera coordinate system.

The transformation of the coordinate system may be performed under the following two conditions. The first condition is that the 3D rotation represented by R_{M→D} and the parallel translation represented by T_{M→D} may enable 3D coordinates X_{D} of all pixels of the brightness images 21 through 24 to be projected onto a location (x, y) of a depth image. The second condition is that 3D coordinates X_{D} of pixels representing a depth image exist on a plane of a calibration.

When the coordinate system is transformed, the image processing apparatus may calculate a constant “k” to satisfy a condition that an actual 3D coordinate X of the target pixel is projected onto the location (x, y) of the depth image. The condition may be represented by the following Equation 3:

X=kX_{D} [Equation 3]

The actual 3D coordinate X refers to a coordinate of a point at which the target pixel of FIG. 4 is actually located, and may be obtained by correcting an error of the measured 3D coordinate X_{D}. Additionally, X=(X, Y, Z)^{T}. The image processing apparatus may calculate a constant “k” that enables the measured 3D coordinate X_{D} to continue to be projected onto the location (x, y) of the depth image.

The actual 3D coordinate X, in particular the corrected 3D coordinate X, may need to be placed on the pattern planes 1 through 4 calculated during the calibration. When plane parameters of the pattern planes 1 through 4 are denoted by a, b, c, and d, a plane equation of the pattern planes 1 through 4 may satisfy the following Equation 4:

aX+bY+cZ+d=0 [Equation 4]

Equation 4 may be calculated for each of the pattern planes 1 through 4. In Equation 4, a, b, c, and d denote constants of the plane equation, and X, Y, and Z denote the parameters of the plane equation.

The image processing apparatus may calculate k using the following Equation 5 that is obtained by substituting Equation 3 into Equation 4:

$$k = - \frac{d}{{aX}_{D} + {bY}_{D} + {cZ}_{D}} \qquad [ Equation 5 ]$$

In Equation 5, a, b, c, and d denote constants of the plane equation, and X_{D}, Y_{D}, and Z_{D} may be obtained using Equation 2. Here, X_{D}=(X_{D}, Y_{D}, Z_{D})^{T}, and ‘^{T}’ denotes Transpose.

The image processing apparatus may calculate an actual depth R of the target pixel using k calculated by Equation 5.

R=kR_{D} [Equation 6]

In Equation 6, R_{D}\sqrt{X_{D}²+Y_{D}²+Z_{D}²}.

Additionally, R_{D} denotes a depth or a distance to a 3D coordinate X_{D} measured by the depth camera, and may be represented as a constant. R denotes a depth or a distance from the depth camera to an actual 3D coordinate X_{D}, and may have a value obtained by correcting a depth error between R_{D} and R. While R and R_{D} are interpreted as a depth, R and R_{D} may be hereinafter interpreted as a distance.

When the actual distance R is calculated, the image processing apparatus may calculate a depth error ΔR of the target pixel using the following Equation 7:

ΔR=R−R_{D} [Equation 7]

In Equation 7, R_{D}=\sqrt{X_{D}²+Y_{D}²+Z_{D}²}.

Additionally, R may be calculated using Equation 6, and R_{D} denotes a constant.

The image processing apparatus may calculate actual depths R for all of the reference pixels of the brightness images 21 through 24 using Equation 6. Also, the image processing apparatus may calculate depth errors ΔR for all of the reference pixels using Equation 7.

The image processing apparatus may represent the calculated depth errors ΔR using a function of the measured depth R_{D}.

As an example, when all of the depth errors ΔR of the reference pixels are calculated, the image processing apparatus may perform modeling of the calculated depth errors ΔR using a function of the measured depths R_{D} of the reference pixels. Here, the measured depths R_{D} may be depths of 3D coordinates obtained by measuring the reference pixels.

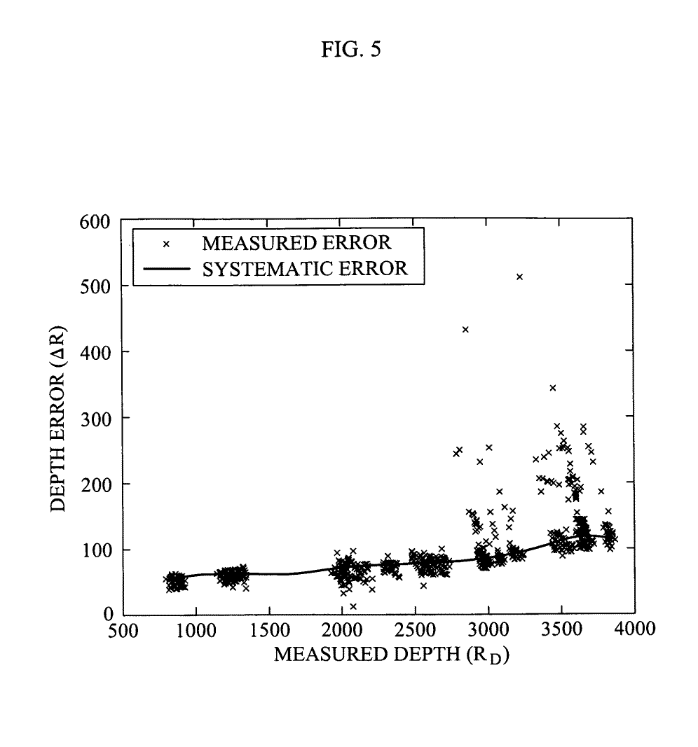

FIG. 5 illustrates an example of modeling of depth errors using a function of a measured depth according to example embodiments. Referring to FIG. 5, ‘x’ marks represent depth errors ΔR calculated for all of the reference pixels, and a line denotes a function fitted to the depth errors ΔR, and denotes a systematic error. For example, the image processing apparatus may perform modeling of the systematic error in the form of a sextic function.

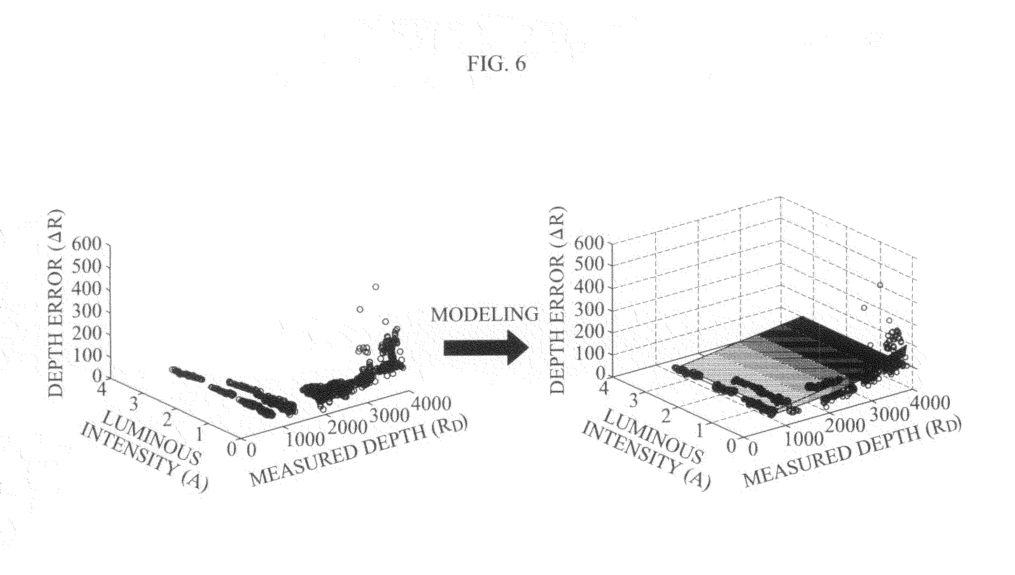

As another example, the image processing apparatus may perform modeling of the calculated depth errors ΔR in the form of a function of the measured depths R_{D} and luminous intensities A of the reference pixels, as shown in FIG. 6.

FIG. 6 illustrates another example of modeling depth errors using the measured depths R_{D} and luminous intensities A. Referring to FIG. 6, dots represent depth errors ΔR calculated based on the measured depths R_{D} and luminous intensities A of reference pixels. Here, when modeling of the depth errors ΔR is performed using a “Thin-Plate-Spline” scheme, the depth errors ΔR for a depth R_{D} and a luminous intensity A that are not actually measured may be interpolated.

The image processing apparatus may perform modeling of the calculated depth errors ΔR using a function of the measured depths R_{D}, the luminous intensities A and the location (x, y) for each of the reference pixels. In other words, when each of the reference pixels has an independent systematic error, the image processing apparatus may adaptively estimate an error function for each of the reference pixels.

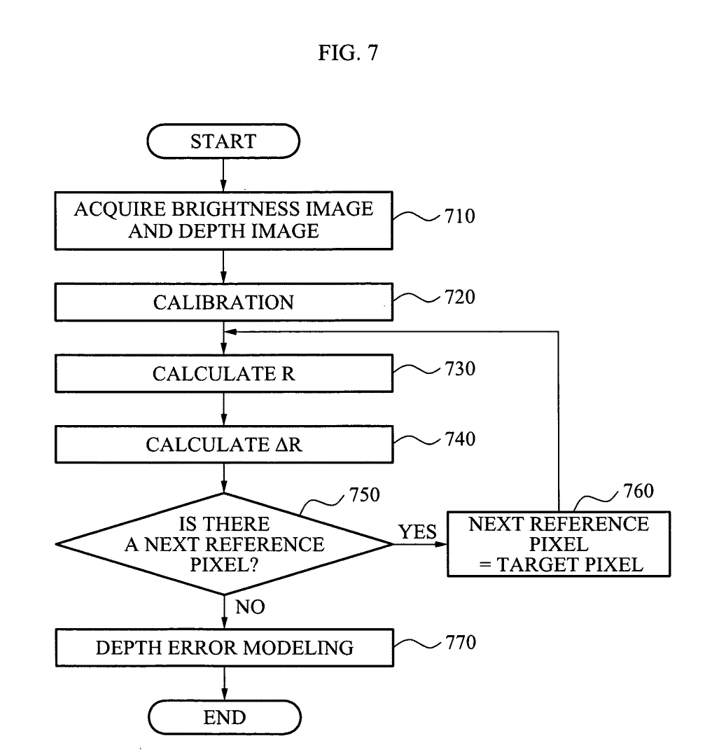

FIG. 7 illustrates a flowchart of an operation of calculating a depth error according to example embodiments.

In operation 710, the image processing apparatus may capture a same reference image using a depth camera, and may acquire at least one brightness image and at least one depth image.

In operation 720, the image processing apparatus may acquire a calibration pattern image of each of the at least one brightness image by applying the camera calibration scheme to the at least one brightness image.

In operation 730, the image processing apparatus may calculate an actual depth R of a target pixel. Here, the target pixel may be a pixel to be currently processed among a plurality of pixels representing the at least one brightness image. The at least one brightness image may be an intensity image. Specifically, in operation 730, the image processing apparatus may calculate the actual depth R by placing a 3D coordinate X_{D} of the target pixel that is measured by the depth camera on a same line as an actual 3D coordinate X of the target pixel. The actual depth R may be a distance between the depth camera and the actual 3D coordinate X. Also, the image processing apparatus may calculate the actual depth R by projecting the measured 3D coordinate X_{D} and the actual 3D coordinate X onto the same pixel (x, y) of a depth image, as well as the above condition. Additionally, the image processing apparatus may calculate the actual depth R using Equations 1 through 6 described above.

In operation 740, the image processing apparatus may calculate a depth error ΔR of the target pixel using Equation 7, and the actual depth R calculated in operation 730.

When there is a next reference pixel of which a depth error ΔR is to be calculated in operation 750, the image processing apparatus may set the next reference pixel as a target pixel in operation 760. Subsequently, the image processing apparatus may repeat operations 730 through 750.

When depth errors ΔR of all of the reference pixels are calculated, the image processing apparatus may perform modeling of the depth errors ΔR in operation 770. For example, the image processing apparatus may perform modeling of each of the calculated depth errors ΔR using a function of the measured depths R_{D} for each of the reference pixels, as shown in FIG. 5. Here, the measured depths R_{D} of the reference pixels may be depths of 3D coordinates acquired by measuring the reference pixels.

Alternatively, the image processing apparatus may perform modeling of each of the calculated depth errors ΔR using a function of the measured depths R_{D} and luminous intensities A for each of the reference pixels, as shown in FIG. 6.

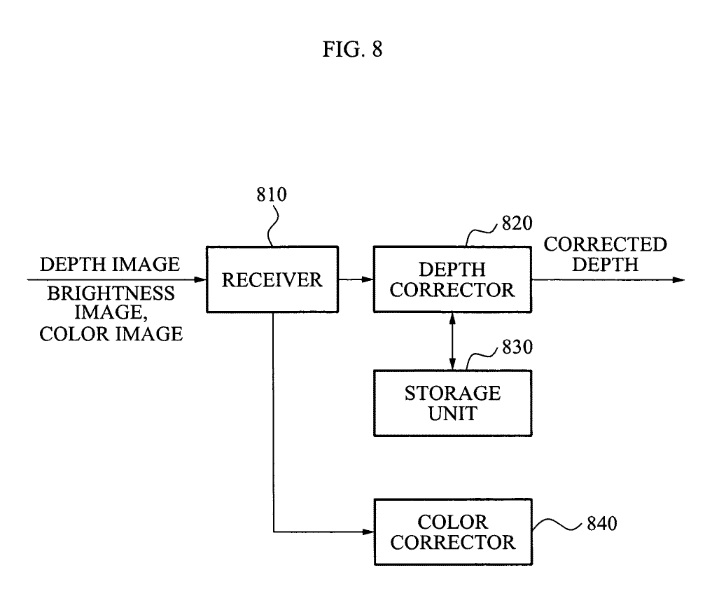

FIG. 8 illustrates a block diagram of an image processing apparatus according to example embodiments.

The image processing apparatus of FIG. 8 may correct a depth image, a brightness image, and/or a color image. Here, the depth image and the brightness image may be acquired using at least one depth camera, and the color image may be acquired by at least one color camera. The depth camera and/or the color camera may be included in the image processing apparatus, and may capture an object to generate a 3D image.

The image processing apparatus of FIG. 8 may be identical to or different from the image processing apparatus described with reference to FIGS. 1 through 7. Specifically, the image processing apparatus of FIG. 8 may include a receiver 810, a depth corrector 820, a storage unit 830, and a color corrector 840.

The receiver 810 may receive the depth image, the brightness image, and/or the color image. The receiver 810 may output, to the depth corrector 820, a 3D coordinate X_{D} of a target pixel, a depth R_{D} of the target pixel, and a measured luminous intensity A of the target pixel. Here, the 3D coordinate X_{D} and the depth R_{D} may be measured by the depth camera. Alternatively, the receiver 810 may output the depth image and the brightness image to the depth corrector 820, and may output the color image to the color corrector 840. The target pixel may be a pixel to be currently processed among a plurality of pixels representing the brightness image. The measured luminous intensity A may be defined as a luminous intensity of each of the plurality of pixels, and may be measured by the depth camera.

The depth corrector 820 may read a depth error ΔR mapped or corresponded to the measured depth R_{D} from the storage unit 830. The depth corrector 820 may correct the measured 3D coordinate X_{D} using the read depth error ΔR. The measured 3D coordinate X_{D} may correspond to the measured depth R_{D}. For example, the depth corrector 820 may correct the depth error ΔR of the measured 3D coordinate X_{D}. The depth error ΔR may be a difference between the measured depth R_{D} and an actual depth from the depth camera to the target pixel, and may be represented as a distance error.

Alternatively, the depth corrector 820 may read the depth error ΔR from the storage unit 830. Here, the depth error ΔR may be mapped or corresponded to the measured depth R_{D} and the measured luminous intensity A of the target pixel. Additionally, the depth corrector 820 may correct the measured 3D coordinate X_{D} using the read depth error ΔR.

The depth corrector 820 may correct the measured 3D coordinate X_{D} using the following Equation 8:

$$X = \frac{R}{{R}_{D}} {X}_{D} \qquad [ Equation 8 ]$$

In Equation 8, R=R_{D}+ΔR.

In Equation 8, R may denote the actual depth of the target pixel, and may be calculated by adding R_{D} and ΔR. R_{D} may denote a constant as a depth measured by the depth camera, and ΔR may denote a depth error corresponding to R_{D} among depth errors stored in the storage unit 830. X_{D} may denote a measured 3D coordinate of a target pixel, and X may denote an actual 3D coordinate of the target pixel and may be obtained by correcting X_{D}.

When the brightness image and the depth image are received, the depth corrector 820 may correct the measured 3D coordinate X_{D} using a function stored in the storage unit 830, or using the modeled depth error ΔR. Specifically, the depth corrector 820 may read the depth error ΔR corresponding to the measured depth R_{D} from the storage unit 830, and may add the measured depth R_{D} and the read depth error ΔR, to calculate the actual depth R. Additionally, the corrected actual 3D coordinate X may be calculated by substituting the calculated actual depth R into Equation 8.

The storage unit 830 may be a nonvolatile memory, to store information used to correct the depth image and the brightness image. Specifically, the storage unit 830 may store the depth error ΔR used to correct a distortion of a depth that occurs due to a luminous intensity and a distance measured using the depth camera.

For example, the storage unit 830 may store the depth error ΔR modeled as shown in FIG. 5 or 6. Referring to FIG. 5, the depth error ΔR corresponding to the measured depth R_{D} may be modeled and stored in the form of a lookup table. Referring to FIG. 6, the depth error ΔR corresponding to the measured depth R_{D} and luminous intensity A may be modeled and stored in the form of a lookup table. The storage unit 830 may also store a function of the depth error ΔR modeled as shown in FIG. 5 or 6.

The stored depth error ΔR may be calculated by the method described with reference to FIGS. 1 through 7. The stored depth error ΔR may be a difference between an actual depth R of each reference pixel representing a reference image and a measured depth R_{D} acquired by measuring each reference pixel. The reference image may include a pattern image where a same pattern is repeated. Each pattern may have different luminous intensities, or neighboring patterns may have different luminous intensities.

The actual depths R of the reference pixels may be calculated by placing measured 3D coordinates X_{D} of the reference pixels on a same line as actual 3D coordinates X of the reference pixels, and projecting the measured 3D coordinates X_{D} and the actual 3D coordinates X onto the location (x, y) of a depth image of the reference image.

Each of the depth errors ΔR stored in the storage unit 830 may be calculated from a plurality of brightness images and a plurality of depth images. Here, the plurality of brightness images and the plurality of depth images may be acquired by capturing a same reference image at different locations and different angles.

The color corrector 840 may correct the color image received by the receiver 810 through a color quantization.

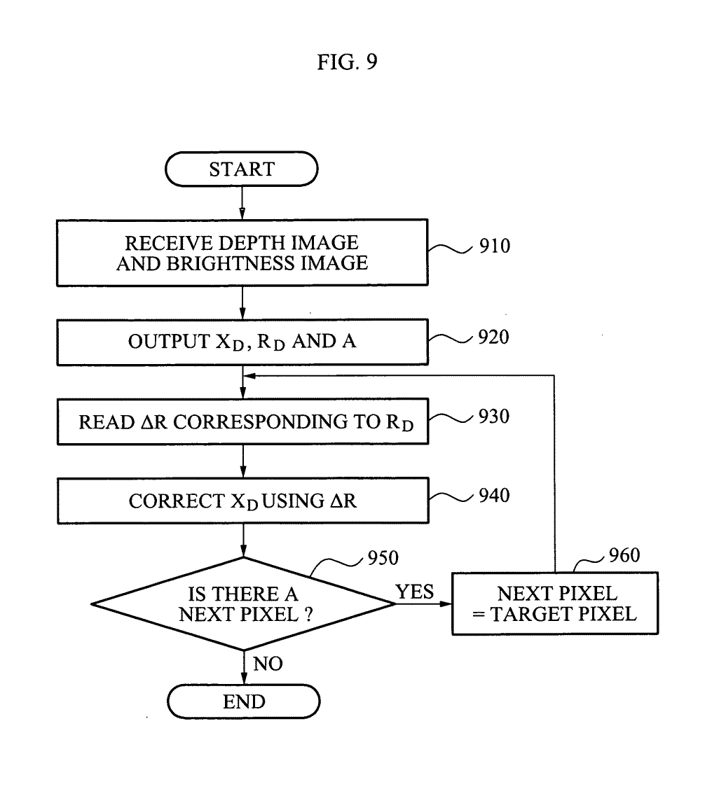

FIG. 9 illustrates a flowchart of an image processing method of an image processing apparatus according to example embodiments.

The image processing method of FIG. 9 may be performed to correct a 3D coordinate of a pixel and accordingly, a description of color image correction will be omitted herein. The image processing method of FIG. 9 may be performed by the image processing apparatus of FIG. 8.

In operation 910, the image processing apparatus may receive a depth image and a brightness image that are captured by a depth camera.

In operation 920, the image processing apparatus may read a measured 3D coordinate X_{D} of a target pixel, a measured depth R_{D} of the target pixel, and a measured luminous intensity A of the target pixel from the received depth image and the received brightness image and may output the 3D coordinate X_{D}, the depth R_{D}, and the luminous intensity A.

In operation 930, the image processing apparatus may read a depth error ΔR of the target pixel from a lookup table. The depth error ΔR may correspond to the measured depth R_{D}, and may be stored in the lookup table.

In operation 940, the image processing apparatus may correct the measured 3D coordinate X_{D} using the read depth error ΔR and Equation 8.

When a next pixel to be processed remains in operation 950, the image processing apparatus may set the next pixel as a target pixel in operation 960, and repeat operations 930 through 950.

The above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. An image processing apparatus, comprising:
a receiver to receive a depth image and a brightness image, and to output a three-dimensional (3D) coordinate of a target pixel and a depth of the target pixel, the depth image and the brightness image captured by a depth camera, and the 3D coordinate and the depth measured by the depth camera;
a correction unit to read a depth error corresponding to the measured depth from a storage unit, and to correct the measured 3D coordinate using the read depth error; and
the storage unit to store the depth error,
wherein a plurality of depth errors stored in the storage unit are corresponded to at least one of a plurality of depths and a plurality of luminous intensities.

2. The image processing apparatus of claim 1, wherein the receiver outputs luminous intensities of a plurality of pixels to the correction unit, the luminous intensities measured by the depth camera.

3. The image processing apparatus of claim 1, wherein the correction unit reads from the storage unit the depth error corresponded to the measured depth and the measured luminous intensity, and corrects the measured 3D coordinate using the read depth error.

4. The image processing apparatus of claim 1, wherein the correction unit corrects the measured 3D coordinate using the following equation:
$$X = \frac{R}{{R}_{D}} {X}_{D} ,$$
where R=R_{D}+ΔR, R denotes an actual depth, R_{D} denotes the measured depth, ΔR denotes the depth error corresponding to the measured depth among the plurality of depth errors stored in the storage unit, X_{D} denotes the measured 3D coordinate, and X denotes an actual 3D coordinate.

5. The image processing apparatus of claim 1, wherein the plurality of depth errors stored in the storage unit are calculated based on differences between actual depths of reference pixels of a reference image and measured depths of the reference pixels.

6. The image processing apparatus of claim 5, wherein the actual depths of the reference pixels are calculated by placing measured 3D coordinates of the reference pixels on a same line as actual 3D coordinates of the reference pixels, and by projecting the measured 3D coordinates and the actual 3D coordinates onto a depth image of the reference image.

7. The image processing apparatus of claim 1, wherein the plurality of depth errors stored in the storage unit are calculated using a plurality of brightness images and a plurality of depth images, the plurality of brightness images and the plurality of depth images acquired by capturing a same reference image at different locations and different angles.

8. The image processing apparatus of claim 7, wherein the reference image is a pattern image where a same pattern is repeated, and the same pattern has different luminous intensities.

9. The image processing apparatus of claim 1, further comprising:
a color corrector to correct a color image received from the receiver.

10. An image processing method, comprising:
receiving, by at least one processor, a depth image and a brightness image, the depth image and the brightness image captured by a depth camera;
outputting, by the at least one processor, a 3D coordinate of a target pixel and a depth of the target pixel, the 3D coordinate and the depth measured by the depth camera;
reading, by the at least one processor, a depth error corresponding to the measured depth from a storage unit, the depth error stored in the storage unit; and
correcting, by the at least one processor, the measured 3D coordinate using the read depth error,
wherein a plurality of depth errors stored in the storage unit are corresponded to at least one of a plurality of depths and a plurality of luminous intensities.

11. The image processing method of claim 10, wherein the receiving comprises outputting luminous intensities of a plurality of pixels, the luminous intensities measured by the depth camera, and
wherein the correcting comprises reading from the storage unit the depth error corresponded to the measured depth and the measured luminous intensity, and correcting the measured 3D coordinate using the read depth error.

12. The image processing method of claim 10, wherein the correcting comprises correcting the measured 3D coordinate using the following equation:
$$X = \frac{R}{{R}_{D}} {X}_{D} ,$$
where R=R_{D}+ΔR, R denotes an actual depth, R_{D} denotes the measured depth, ΔR denotes the depth error, X_{D} denotes the measured 3D coordinate, and X denotes an actual 3D coordinate.

13. The image processing method of claim 10, wherein the plurality of depth errors are calculated based on differences between actual depths of reference pixels of a reference image and measured depths of the reference pixels.

14. The image processing method of claim 13, wherein the actual depths of the reference pixels are calculated by placing measured 3D coordinates of the reference pixels on a same line as actual 3D coordinates of the reference pixels, and projecting the measured 3D coordinates and the actual 3D coordinates onto a depth image of the reference image.

15. The image processing method of claim 10, wherein the plurality of depth errors are calculated using a plurality of brightness images and a plurality of depth images, the plurality of brightness images and the plurality of depth images acquired by capturing a same reference image at different locations and different angles.

16. The image processing method of claim 15, wherein the reference image is a pattern image where a same pattern is repeated, and the same pattern has different luminous intensities.

17. An image processing method, comprising:
capturing, by at least one processor, a calibration reference image by a depth camera, and acquiring a brightness image and a depth image;
calculating, by the at least one processor, an actual depth of a target pixel by placing a 3D coordinate of the target pixel measured by the depth camera on a same line as an actual 3D coordinate of the target pixel;
calculating, by the at least one processor, a depth error of the target pixel using the calculated actual depth and a depth of the measured 3D coordinate; and
performing modeling of the calculated depth error using a function of measured depths of reference pixels when all depth errors of the reference pixels are calculated, where the measured depths are depths of 3D coordinates obtained by measuring the reference pixels.

18. The image processing method of claim 17, wherein the performing of modeling comprises performing modeling of the calculated depth error using a function of the measured depths of the reference pixels and luminous intensities of the reference pixels.

19. The image processing method of claim 17, wherein the calculating of the actual depth comprises calculating the actual depth of the target pixel by projecting the measured 3D coordinate of the target pixel and the actual 3D coordinate of the target pixel onto a same pixel of the depth image, by placing the measured 3D coordinate of the target pixel on the same line as the actual 3D coordinate of the target pixel.

20. At least one non-transitory computer readable recording medium comprising computer readable instructions that control at least one processor to implement a method, comprising:
receiving a depth image and a brightness image, the depth image and the brightness image captured by a depth camera;
outputting a 3D coordinate of a target pixel and a depth of the target pixel, the 3D coordinate and the depth measured by the depth camera;
reading a depth error corresponding to the measured depth from a storage unit, the depth error stored in the storage unit; and
correcting the measured 3D coordinate using the read depth error,
wherein a plurality of depth errors stored in the storage unit are corresponded to at least one of a plurality of depths and a plurality of luminous intensities.

21. A method, comprising:
capturing, by at least one processor, a brightness image and a depth image;
calculating, by the at least one processor, a depth and a 3D coordinate of a target pixel;
determining, by the at least one processor, a depth error by comparing the depth of the target pixel with a table of depth errors; and
correcting the 3D coordinate using the depth error.

22. The method of claim 21, wherein the table of depth errors is responsive to at least one of a plurality of depths and a plurality of luminous intensities and is determined using a reference image captured from a plurality of locations and angles.
